(19) United States
(12) Patent Application Publication
(10) Pub. No.: US 2003/0015584 A1
(43) Pub. Date: Jan. 23, 2003

(54) Magnetic or bar code reader device and a method for data transmission

(76) Inventor: Sadao Isuyama, Sao Paulo (BR)

Correspondence Address: BIRCH STEWART KOLASCH & BIRCH, PO BOX 747, FALLS CHURCH, VA, 22040-0747, US

(21) Appl. No.: 09/908,497

(22) Filed: Jul. 19, 2001

(51) Int. Cl. G06K 5/00

(52) U.S. Cl. 235/380

(57) ABSTRACT

A magnetic code or bar code reader for transmitting data to an audible answer telephone exchange, connected between a telephone line outlet and a telephone set, which includes a magnetic strip and/or bar code sensing unit and a central processing unit board, containing a microprocessor, a non-volatile memory and the telephone dialing interface, and wherein the reader device also has an outlet for connection to a telephone line and another outlet for connection to a telephone set, also included is a method for data transmission between an audible answer exchange by means of a telephone line using the reader.

### TECHNICAL FIELD

The present invention is related to the field of authorization transactions via telephone call with an audible answering unit (AAU) telephone exchange. More specifically, the present invention relates to an associated apparatus for automatically sending identification data of a user and of a merchant to the AAU exchange. According to a second embodiment, the present invention refers to the field of user authorization transactions to make telephone calls in KS or PABX type telephone exchanges. More specifically, the invention refers to an associated apparatus for automatically sending user identification data to a telephone call controller.

AAU exchanges are equipment that automatically answer telephone calls and are operated by the user by keying options or numbers on the telephone set. On the other hand, telephone call controllers are equipment that, by means of an access code, enable or inhibit a user to place certain telephone calls, such as local, long-distance or international calls.

### BACKGROUND OF THE INVENTION

Many types of transactions and access to services are authorized by means of telephone calls. The user/subscriber presents his identification/credit/debit/access card to the merchant and the latter performs the check or the transaction via telephone, dialing the number of an AAU. The telephone query is the most widely used form when these services are offered in a decentralized manner.

Some examples of these services are: grant of credit for purchases, use of a service warranted by an insurance policy upon an accident, loans, payment of bills., etc.

Without the availability of the device, the operation is presently as follows:

A number on the telephone set is dialed in order to establish a call to the AAU exchange;

Upon the call being answered by the AAU exchange, the telephone set keys are utilized to enter the identification number of the merchant;

The telephone set keys are used to enter the identification number of the user;

The telephone set keys are used to enter complementary data; and

The authorization is returned.

The data keying sequence may vary.

Due to a manual keying process, this operation is subject to keying errors, delays and security problems since the transmitted data may be easily extracted by means of a listening device eventually plugged into the telephone line.

The identification cards, in many cases, have magnetic strips or bar codes in order to be used in electronic credit card terminals (POS), in automatic commerce terminals (PDV), in automatic bank tellers, etc. The cost of this types of equipment is relatively high and the use thereof is most often appropriate only in establishments (shops) of major size or very frequently used. In the case of businesses where the cost of the equipment is not adequate, such as in small businesses or infrequently used locations, the operation is performed by means of a telephone call to an AAU. In this case the operation is performed manually and the magnetic strip or the bar code that is present in the identification card is not used.

As an alternative, in many companies and hotels, the use of the telephone is subject to control. Some users are authorized to make only certain types of telephone calls. In order to control the use of the telephone, the companies usually block the extensions in connection with performance of certain functions. In the case of hotels, the room extensions are blocked, and are unblocked when a guest checks in to a room. In some exchanges, the user may unblock the line using an access code that has to be keyed in on the telephone set itself.

Some of the problems associated with this type of control are the following:

In a company, an unauthorized user may establish any telephone call through an unblocked extension, without being identified.

In a company, a user that is normally authorized to establish certain types of calls will be unable to establish calls from blocked extensions.

In a company, it is difficult to identify the users that established the telephone calls.

In a hotel, unauthorized individuals, such as chambermaids, will be able to establish telephone calls from guest rooms.

In a hotel, when a guest denies having made a certain telephone call, the hotel will have no evidence as to who actually made the call.

When there are used control exchanges wherein access is granted by means of passwords, the user will have trouble remembering the password and there may occur keying errors, due to the manual nature of the process.

### SUMMARY OF THE INVENTION

The present invention refers, according to a first embodiment thereof, to a magnetic or bar code reader incorporating the dialing interface of a telephone. By means of such device, the process of dialing, keying the user identification number and the merchant identification number, is automated in an operation using an AAU exchange.

The device reads the data contained in the magnetic strip or the bar code of the identification card and transmits this data through the telephone line to the AAU exchange.

The device is connected to the telephone line as shown in FIG. 1.

When the dialing button (FIG. 2) is pressed, the device will dial the preset number of the AAU exchange.

Upon request of the user identification number, the card bearing the user identification number is simply passed through the slot in the reading device. The device will automatically transmit the requested data that is encoded in the card.

The merchant identification number may be stored in the memory of the device and may be transmitted together with the user code, as well as there may be used a merchant identification card by passing the same through the slot in the reader in order to transmit the data.

According to the device described in the second version, the process of dialing, and entering the user identification number, is automated in an extension unblocking operation.

The device reads the data contained in the magnetic band or the bar code of the identification card and transmits the said data through the telephone line to the telephone control exchange.

The device is connected to the telephone line as shown in FIG. 4.

The extension should be normally blocked for functions such as long-distance and international calls, etc., that are intended to be controlled by means of the system.

Upon taking the phone off the hook, the user should pass the card bearing the magnetic code or the bar code through the slot in the reader. The device will automatically transmit the user identification data to the control exchange. The control exchange will automatically enable the call functions allowed for this user.

The card used may be the employee identification tag itself in the case of a company or the card that is used, maybe a passkey, in the case of hotels.

### BRIEF DESCRIPTION OF THE DRAWINGS

The present invention will become more fully understood from the detailed description given hereinbelow and the accompanying drawings, which are given by way of illustration only, and thus are not limitative of the present invention, and wherein,

FIG. 1 is a schematic drawing showing the arrangement of the device according to a first embodiment of the present invention in a telephone circuit;

FIG. 2 is a block diagram of the device according to the first embodiment of the present invention, in itself;

FIG. 3 is a block diagram of an entire system for authorizing telephone calls including the device according to the first embodiment of the present invention;

FIG. 4 is a schematic drawing showing the arrangement of the device according to a second embodiment of the present invention, in a telephone circuit;

FIG. 5 is a block diagram of the device according to the second embodiment of the present invention, in itself; and

FIG. 6 is a block diagram of an entire system for authorizing telephone calls including the device according to the second embodiment of the present invention.

### DETAILED DESCRIPTION OF THE INVENTION

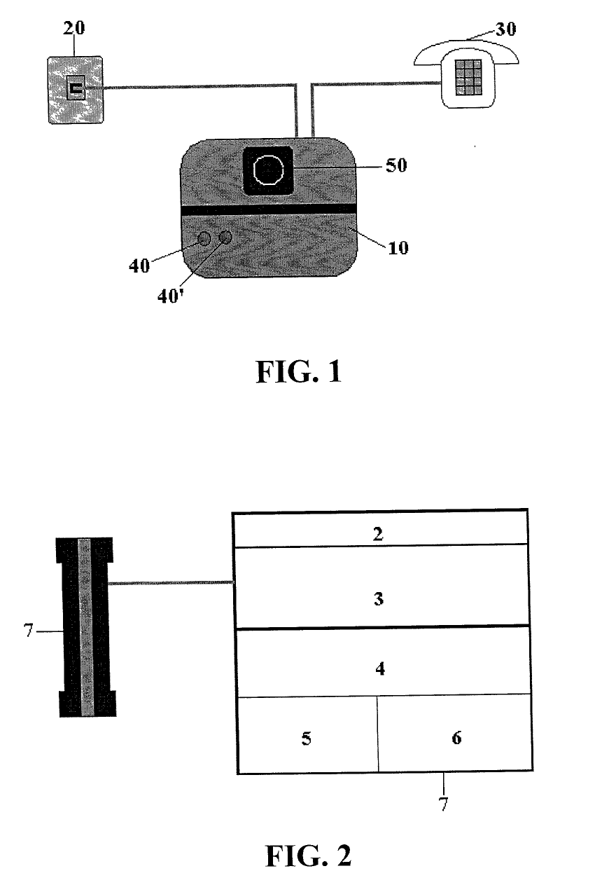

As depicted in FIG. 1, the device 10 according to the present invention is connected between a telephone line outlet 20 and a telephone set 30. Externally, the device 10 comprises a dialing button 50 and operating lights 40, 40′ (for example, green/red).

The device includes a magnetic band and/or bar code sensing unit 1 and a central processing unit (CPU) board 7.

Board 7 contains a microprocessor 3, a non-volatile memory 2 and the telephone dialing interface 4. It also comprises an outlet 5 for connection to a telephone line and another outlet 6 for connection to a telephone set (FIG. 2).

The supply of power to the assembly (sensor 1+CPU board 7) can be provided through the telephone line itself.

The device does not interfere with the operation of the telephone set, which continues to operate in the normal manner.

Description of the Circuit (First Embodiment)

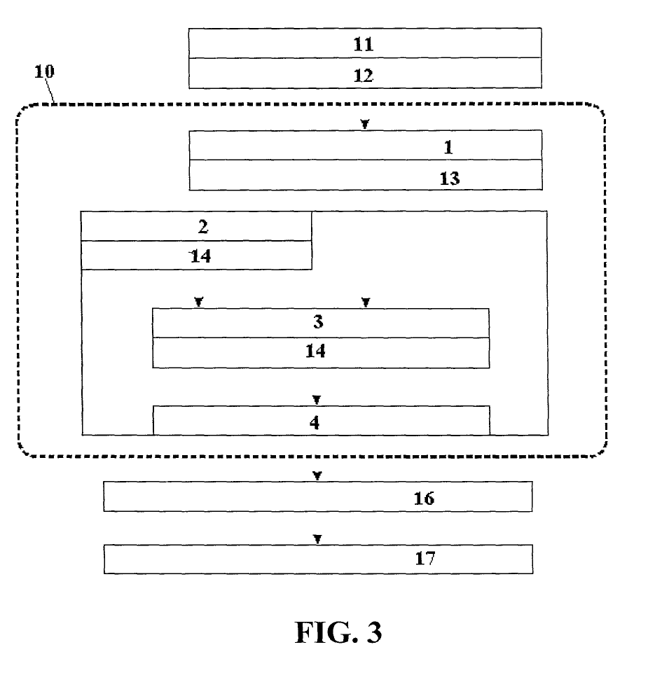

The complete circuit (FIG. 3) begins with a document 11 having a bar code 12, that is made to pass through the device, where the latter includes the sensing unit 1 having an optical bar code scanning sensor and/or a magnetic pickup head, and which is interconnected with an amplifier/digitizer circuit 13. The signal that is generated is sent to the microprocessor 3. Auxiliary data 14 is stored in the memory 2. The microprocessor decodes these signals and prepares the data 15 to be transmitted to the data transmission circuit. When preparing the data, the microprocessor may encrypt the data to be transmitted to the telephone interface 4. The data transmission circuit converts the data to multifrequency signals (tone) or decade count signals (pulse) and transmits the same to the AAU exchange 17 by means of the telephone line 16.

In order to dial a call to the AAU exchange, the device uses the multifrequency or decade count signal generation circuit.

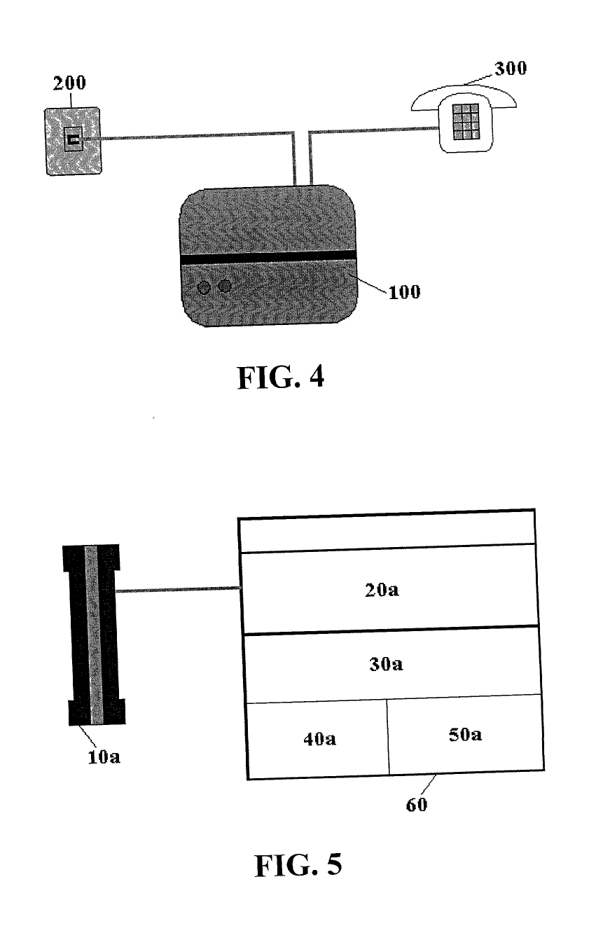

As shown in FIG. 4, the device 100 according to the second embodiment of the present invention is connected between a telephone line outlet 200 and a telephone set 300.

The device includes a magnetic tape and/or bar code sensing unit 10a and a central processing unit (CPU) board 60.

The board 60 includes a microprocessor 20a and the telephone dialing interface 30a, an outlet 40a for connection to a telephone line and another outlet 50a for connection to a telephone set (FIG. 5).

The supply of power to the assembly (sensor 10a+CPU board 60) can be made through the telephone line, itself.

The device does not interfere in the operation of the telephone set, which continues to operate in a normal manner.

Description of the Circuit (Second Embodiment)

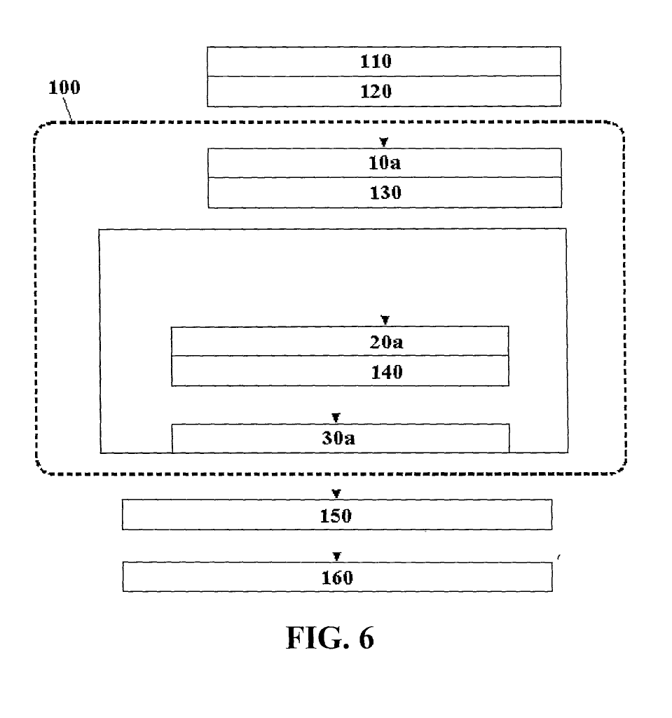

The complete circuit (FIG. 6) begins with a card 110, having a magnetic strip or a bar code 120 that is made to pass through the device, where the latter includes the sensing unit 10a containing an optical bar code scanning sensor and/or a magnetic pickup head, and which is interconnected with an amplifier/digitizer circuit 130. The signal thus generated is sent to the microprocessor 20a. The microprocessor 20a decodes these signals and prepares the data 140 to be transmitted to the data transmission circuit. When preparing the data, the microprocessor may encrypt the data to be transmitted to the telephone interface 30a. The data transmission circuit 30a converts the data to multifrequency signals (tone) or decade count signals (pulse) and transmits the same to the telephone control exchange 160 by means of the telephone line 150.

In order to dial a call to the telephone control exchange, the device uses the multifrequency or decade count signal generation circuit.

The benefits of the first embodiment of the present invention are listed below:

Easiness of operation.

Fast data transmission,.

Shorter telephone line engagement time.

Shorter AAU engagement time.

Increased reliability of transmitted data.

The data may be encrypted, allowing better security in the transmission.

Possibility to send an increased amount of data from the card.

The benefits of the second embodiment of the present invention are listed below:

Easiness of operation.

Fast identification data transmission.

Shorter telephone line engagement time.

Increased reliability of transmitted data.

In a company, the control of telephone calls may be made by user and not by extension. There may be thus designated the functions that will be authorized for each user, irrespective of the extension used.

The users that established each telephone call may be identified subsequently, including in cases where the extension is used by several users.

In a company, there may be used as the system identification card the employee identification tag itself. In this case there will be no need to acquire additional cards.

In a hotel, the room extensions may be normally blocked, inhibiting access by unauthorized persons.

The will relieved from having to memorize the access code to unblock the extension.

In a hotel, the magnetic card that is used as the room key may also be used as a system access card. In this case there will be no need to acquire additional cards.

At the control exchange there may be implemented functions such as maximum calling time allowed for each user.

The transmission of identification data may be encrypted, allowing access only with the card and the consequent identification of the user.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

1. A magnetic strip or bar code reader device for transmitting data to an audible answer exchange unit, connected between a telephone line outlet and a telephone set, which comprises a magnetic strip and/or bar code sensing and a central processing unit board which includes a microprocessor, a non-volatile memory and the telephone dialing interface and wherein an outlet for connection to a telephone line and another outlet is provided for connection to a telephone set.

2. The reader device according to claim 1, wherein the supply of power to the sensing unit and the central processing unit board is provided by means of the telephone line itself.

3. The reader device according to claim 1, wherein the sensing unit includes an optical bar code sensor and/or a magnetic pickup head interconnected with an amplifier/digitizer circuit.

4. The reader device according to claim 1, wherein the data transmitted to the audible answer exchange is encrypted.

5. A method for transmitting data to an audible answer exchange, wherein a document including a magnetic code or a bar code is passed through a code reading device that includes a sensing unit having an optical bar code sensor and/or a magnetic pickup head, interconnected with an amplifying/digitizing circuit, and whereupon the signal generated thereby is sent to a microprocessor, the auxiliary data being stored in a memory, whereby the microprocessor decodes these signals and prepares the data to be transmitted to a data transmission circuit that converts the data to multifrequency signals (tone) or decade count signals (pulse) and transmits the same to an audible answer exchange by means of a telephone line 16.

6. The method according to claim 5, wherein, when preparing the data, the microprocessor encrypts the data to be transmitted to a telephone interface.

7. A magnetic strip or bar code reader device for transmitting data to an audible answer exchange unit, connected between a telephone line outlet and a telephone set which comprises a magnetic strip and/or bar code sensing unit and a central processing unit board which includes a microprocessor and the telephone dialing interface and wherein an outlet is provided for connection to a telephone line and another outlet for connection to a telephone set.

8. The reader device, according to claim 7, wherein the supply of power to the sensing unit and the central processing unit board is provided by means of the telephone line itself.

9. The reader device, according to claim 7, wherein the sensing unit includes an optical bar code sensor and/or a magnetic pickup head interconnected with an amplifier/digitizer circuit.

10. The reader device, according to claim 7, wherein an employee identification card (tag) or a magnetic pass key is used as an access card to access the system.

11. The reader device, according a claim 7, wherein the data transmitted to the audible answer exchange are encrypted.

12. A method for transmitting data to a telephone call control exchange, wherein a card with a bar code or a magnetic code is passed through a code reading device that includes a sensing unit having an optical bar code sensor and/or a magnetic pickup head, interconnected with an amplifying/digitizing circuit, whereupon the signal having thus been generated is sent to a microprocessor and in the subsequent step, the microprocessor decodes these signals and prepares the data for transmission to a data transmission circuit which converts the data to multifrequency signals (tone) or decade count signals (pulse) and transmits the same to a telephone call control exchange by means of a telephone line.
